(19) United States
(12) Patent Application Publication
(10) Pub. No.: US 2020/0074375 A1
(43) Pub. Date: Mar. 5, 2020

(54) PRODUCT MATURITY DETERMINATION IN A TECHNICAL SYSTEM AND IN PARTICULAR IN AN AUTONOMOUSLY DRIVING VEHICLE

(71) Applicant: dSPACE digital signal processing and control engineering GmbH, Paderborn (DE)

(72) Inventor: Holger NAUNDORF, Paderborn (DE)

(73) Assignee: dSPACE digital signal processing and control engineering GmbH, Paderborn (DE)

(21) Appl. No.: 16/678,459

(22) Filed: Nov. 8, 2019

Related U.S. Application Data
(63) Continuation of application No. PCT/EP2018/061759, filed on May 8, 2018.

(30) Foreign Application Priority Data
May 9, 2017 (EP) 17170127.9

(51) Int. Cl. G06Q 10/06; G06N 7/00

(52) U.S. Cl. CPC G06Q 10/06395; G06N 7/005

(57) ABSTRACT

A method to determine a product maturity by means of tests, wherein a test comprises executing a test case by means of a test environment applied to a system under test, and for at least one test there is no result; and the method comprises the steps of predetermining rules for calculating a probability that a test that does not currently have a result will be successful or unsuccessful, wherein available or expected results of tests are used as input variables for the rules, and probabilities are returned as output variables; and calculating the probability that a test with no available result will be successful by means of at least some of the predetermined rules; and presenting the product maturity as a function of the probabilities calculated in the previous step.

This nonprovisional application is a continuation of International Application No. PCT/EP2018/061759, which was filed on May 8, 2018, and which claims priority to European Patent Application No. 17170127.9, which was filed in Europe on May 9, 2017, and which are both herein incorporated by reference.

### BACKGROUND OF THE INVENTION

### Field of the Invention

The present invention relates to a method and a test system for determining a product maturity of a technical system.

### Description of the Background Art

Particularly in the area of semi-autonomous or autonomous vehicles, there is a need to test vehicles, vehicle parts (for example electronic control units) and driving functions (for example as algorithms of the software that is run on the control units). Because these driving functions are considered safety-critical to a great extent, it is necessary to define and verify a sufficiently safe criterion level for releasing the next development step. This is particularly the case after completion of the last development step, because that is when mass production of the vehicle begins. This is particularly difficult in the case of semi-autonomous or autonomous vehicles, because the number of all possible scenarios that could be tested is virtually infinite due to the realities of the driving environment, which could never be completely modeled. Accordingly, it is necessary to find a criterion for releasing the next development step that is meaningful, may be verified in a reasonable amount of time, and is sufficiently safe.

Methods for determining product maturity are known from the prior art, in which the product maturity of a technical system is determined by means of test coverage. “Test coverage” herein generally refers to the ratio of executed tests to the total number of tests that may be executed for the technical system, or the ratio of successfully-executed tests to the total number of tests that may be executed for the technical system. In the publication of European patent application EP3082000A1, which corresponds to US 2016/0305853, which is incorporated herein by reference, product maturity is determined by means of test coverage and suggestions are made for improving test coverage.

### SUMMARY OF THE INVENTION

It is therefore an object of the present invention to provide an apparatus that improves on the prior art for determining a product maturity.

According to an exemplary embodiment of the invention, a method is provided for determining a product maturity by means of tests, wherein a test comprises executing a test case by means of a test environment applied to a system under test, and at least one test does not currently have a result; and the method comprises the steps of predetermining rules for calculating a probability that a test without an available result will be successful or unsuccessful, wherein the available or expected results of tests are used as input variables for the rules, and probabilities are returned as output variables; calculating the probability that a test with no available result will be successful by means of at least some of the predetermined rules; and presenting the product maturity as a function of the probabilities calculated in the previous step.

An advantage of the method according to the invention is that the product maturity of a technical system is not evaluated solely on the basis of tests that have already been executed; instead, not-yet-executed tests are also considered. In the event that not all tests are executed, this results in a more complete overall picture of product maturity; otherwise, more meaningful statements on product maturity are obtained at an earlier point in time, because the tests that are still in the future are also included in the evaluation. In addition, on the basis of this future-oriented outlook, an improved selection may be made of the not-yet-executed tests and how they should be sequenced. It is also advantageous that the method makes it easier to find and present representations of product maturity that are easily accessible but also meaningful. Statements on product maturity may readily be summarized or grouped by available criteria, such as for example available test cases, test environments, or systems under test.

In an embodiment, a system under test (SUT) is an at least partially autonomously driven vehicle, a part of an at least partially autonomously driven vehicle or a functionality of an at least partially autonomously driven vehicle; and a test case (TC) is a driving maneuver of the at least partially autonomously driven vehicle, a driving maneuver with the part of the at least partially autonomously driven vehicle or a driving maneuver in which the functionality of an at least partially autonomously driven vehicle is taken into account; and a test environment (TE) is an environment, in particular also a virtual environment, of the at least partially autonomously driven vehicle or of a vehicle comprising the part of the at least partially autonomously driven vehicle or the functionality of an at least partially autonomously driven vehicle. There can also be a first and a second version of a test case or test environment or a system under test, and the second version represents a development state of the test case or test environment or system under test that is later in time than the development state of the first version of the test case or test environment or system under test.

In an example, either by means of the rules or provided in addition to the rules, a part of the present and expected results of the tests is not taken into account when calculating the probability that a test will be successful or not successful, wherein the part of the results that is not taken into account depends on one or more versions of at least one test case, at least one test environment and/or at least one system under test, wherein the test comprises the at least one test case, the at least one test environment and/or the at least one system under test. The predetermined rules can represent a technical or statistical relationship between a first test case, a first test environment or a first system under test in the first or second version, and a second test case, a second test environment or a second system under test in the first or second version.

The result of a test may have at least the values “Test successful” (passed) and “Test failed”. The predetermined rules can be automatically created and/or verified by analyzing a database of at least a part of the tests, comprising test cases, test environments, systems under test and results.

The analysis can comprise a static evaluation of the relationships between tests, in particular the relationships between tests with positive results.

A first group of tests can be determined by means of a statistical distribution before the step of calculating probability, wherein results are available or generated for the first group of tests.

The determination of the tests in the first group can be based on one or more additional static distributions of test cases, test environments and/or systems under test. The static distribution and/or one or more of the other static distributions can be random distributions.

The calculation of the probability that a test with no available result will be successful may be a function of the static distribution of the tests, test cases, test environments and/or systems under test.

The presentation of the product maturity can take the form of a numerical test coverage, in particular a percentage, or in the form of a graphic, in particular a color-coded graphic.

One or more criteria can be predetermined and a part of the tests for which a probability that the test will be successful or unsuccessful has been calculated in the second step are executed or proposed for execution, wherein the tests that have been executed or proposed for execution meet at least one of the predetermined criteria.

At least one of the predetermined criteria can be that a threshold value for the probability that the test will be successful or unsuccessful either is exceeded or is not reached. In another embodiment, a weighting is assigned to a test case (TC), a test environment (TE), a system under test (SUT) or a combination of at least two elements comprising test case (TC), test environment (TE) and system under test (SUT), and the weighting is taken into account in the second step when calculating the probability that a test with no available result will be successful or unsuccessful in the second step and/or when presenting the product maturity in the final step.

A product maturity threshold value can be specified, and if the product maturity threshold value is exceeded, the system under test (SUT) is released for a further development step.

The system under test can be assigned to a class of systems under test (SUT), in particular by means of a level of automation, and the product maturity threshold value is determined as a function of the assigned class.

The object of the invention is likewise achieved by a test system for testing a technical system, wherein the test system executes the methods described above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically depicts the composition of a test from a test environment, test case and system under test;

FIG. 2 schematically depicts the relationships between the test, test environment, test case, system under test and test result;

FIG. 3 schematically depicts the storage of test cases and systems under test and the derivation of different tests from them;

FIG. 4 schematically depicts the prediction of test results of tests that have not been executed, by means of rules;

FIG. 5 schematically depicts the prediction of test results of tests that have not been executed, by means of rules;

FIG. 6 depicts a tabular representation of test results related to different versions of a system under test;

FIG. 7 depicts a tabular representation of predicted results of a test;

FIG. 8 schematically depicts the derivation of rules from the tests and test results that are stored or deposited in a data repository;

FIG. 9 schematically depicts an at least partially autonomously-driven vehicle; and,

FIG. 10 schematically depicts a division of at least partially autonomously-driven vehicles into classes with different levels of automation.

### DETAILED DESCRIPTION

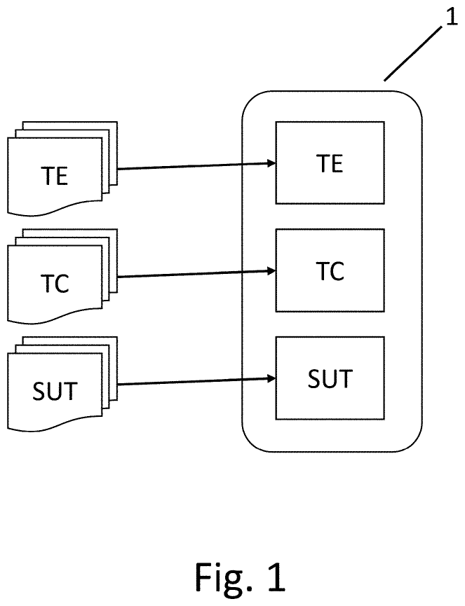

FIG. 1 schematically illustrates the composition of a test (1). A test (1) comprises at least one test environment (TE) taken from a possible plurality of test environments (TE), one test case (TC) taken from a possible plurality of test cases (TC) and a system under test (SUT) taken from a possible plurality of systems under test (SUT).

The purpose of determining the maturity of a technical system is to evaluate product characteristics such as performance, reliability or user-friendliness. This determines whether a next step, known as a milestone, has been reached in the development of the technical system. In most cases, the final milestone is the release of the product for sale or the delivery of the product. One area in which product maturity plays a major role, particularly in terms of reliability and safety, is the automotive sector, including the development of electronic control units (ECUs). The systems under test (SUT) may therefore be ECUs, software to be executed on the ECUs, or a part of this software. The selection of test cases (TC) here depends, among other things, on the functionality to be tested and the safety and reliability goals that must be achieved.

In the automotive industry, “hardware-in-the-loop” (HIL) tests have become established for ensuring the safety of real ECUs. Test cases (TC) may be developed and executed on HIL test environments (usually specialized real-time computers) using appropriate testing tools. One example of such a testing tool is the software product AutomationDesk from the company dSPACE. When testing ECU software, offline simulation environments are also used, some of which may be run on commercially available PCs. A plurality of similar or different test environments (TE) of the kinds shown here by way of example, HIL and offline simulators, may be used for testing. As a result, different test environments (TE) may potentially be used for the test cases (TC).

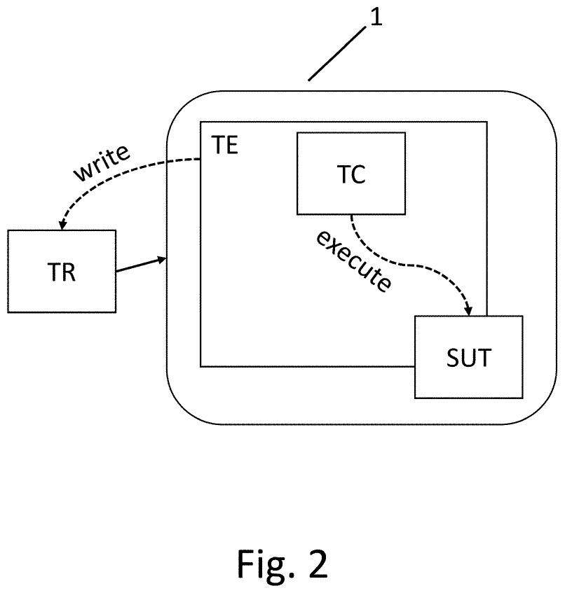

FIG. 2 schematically illustrates relationships between a test (1), test environment (TE), system under test (SUT) and result (TR) of a test (1). When executing a test (1), data are collected that at least partially represent a result (TR) of the test (1), or from which a result (TR) of the test (1) may be derived. Typically, a test case (TC) is executed in or using a test environment (TE) in order to test a system under test (SUT). During or after this execution, results (TR) of the execution of the test (1), namely test results (TR), are recorded, for example by writing a file. These results (TR) are assigned to the test (1), so that it is possible to retrace the conditions of the corresponding test execution during later evaluation of the test results (TR). Typical results (TR) of tests (1) are “passed” (successful) and “failed” (unsuccessful). Because the terms “passed” and “failed” are more commonly used in testing and test management, they are also used below.

For example, if the technical system being tested is an ECU for an automobile, the system under test (SUT) is typically a prototype of this control unit, which is connected to an HIL simulator.

In this case, the HIL simulator and the test software that can be executed on it make up a test environment (TE). The exact configuration of the HIL simulator in this case is relevant for the traceability and reproducibility of the tests (1), and is defined as a test environment (TE). Changes to the hardware or software of the HIL simulator result in a new test environment (TE). After the test (1) comprising the test environment (TE), the test case (TC) and the system under test (SUT) has been executed, the results (TR) of the test (1) are stored and are linked to the test (1) for traceability purposes. This data is preferably stored in a database and managed by a test management tool connected to the database. An example of such a test management tool is the SYNECT software from the company dSPACE.

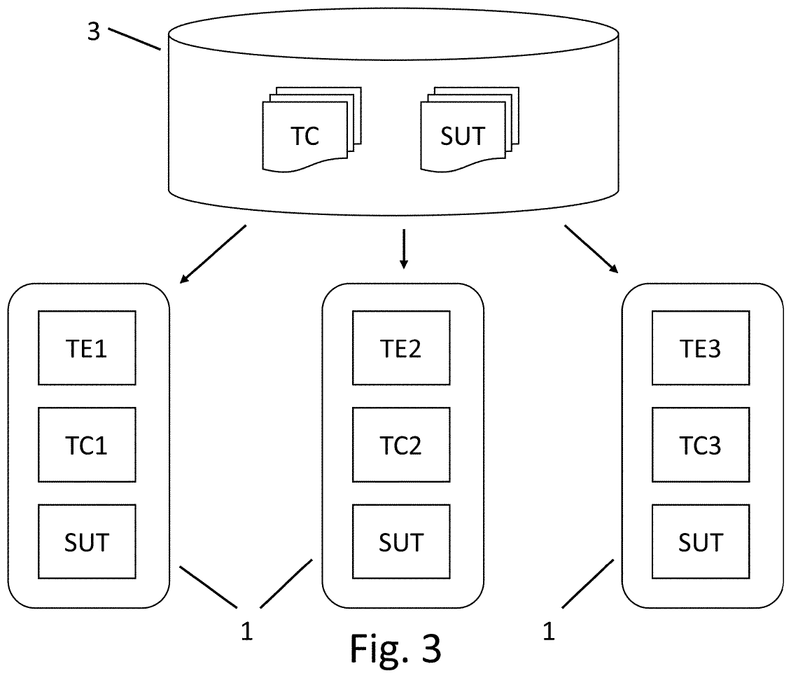

FIG. 3 schematically illustrates the storage of test cases (TC) and systems under test (SUT) in a data repository (3). The data repository may be a file system, a database or another electronic data storage known from the prior art. Likewise, it is possible that only representatives of the actual test cases (TC) or systems under test (SUT) or references to the actual test cases (TC) or systems under test (SUT) are stored in the data repository. This may be useful or even necessary, for example, if the systems under test are not electronically available data, but physically available objects (for example electronic devices). Different tests (1) may then be generated from the stored test cases (TC) and systems under test (SUT) by distributing them to one or more test environments (TE).

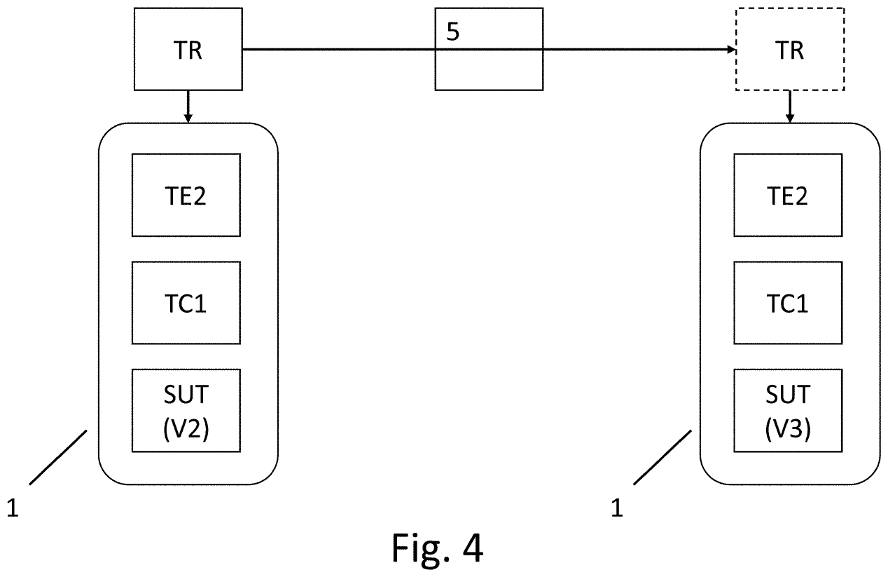

FIG. 4 schematically illustrates the determination of expected test results (TR) according to the invention. To distinguish the expected test results (TR) from the existing test results (TR), the drawings show the former with dashed lines instead of solid lines. Rules (5) are used to calculate the test results (TR) and the assigned probabilities. These rules (5) may be predetermined by the user or may be created automatically by evaluating existing data sets. One example of such a rule is that a test (1) that comprises a system under test (SUT) in a third version (V3) provides 99% of the same test result (TR) as a test (1) comprising the same system under test (SUT) in a second version (V2), if the test environment (TE) and test case (TC) are the same in both tests (1).

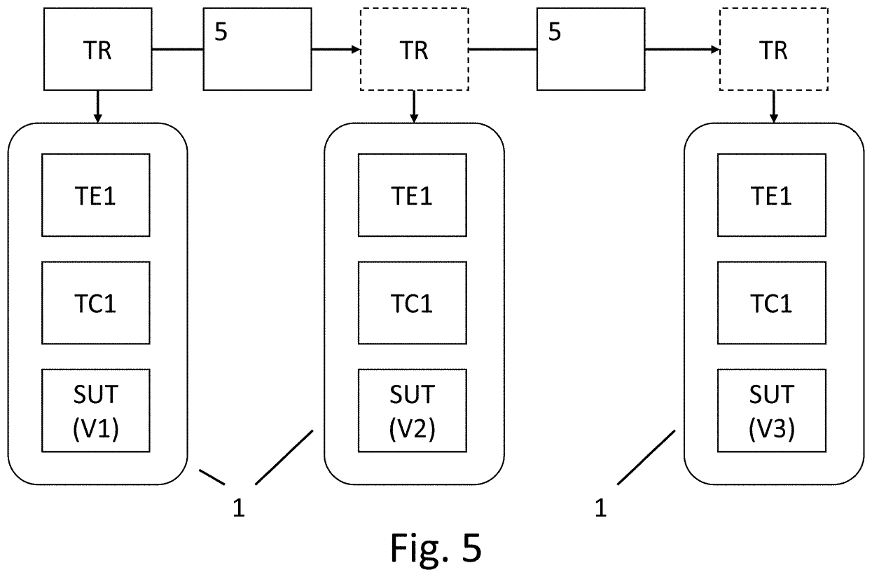

FIG. 5 likewise schematically illustrates the determination of expected test results (TR) according to the invention. The above-described calculation of a test result (TR) may also be derived from a test result (TR) that was previously calculated using a rule (5), instead of an existing test result (TR). This case is shown in FIG. 5, where the tests shown (1) differ only in the version (V1, V2, V3) of the system under test (SUT). The expected result of the test comprising version 2 (V2) of the system under test (SUT) is calculated by means of a rule (5) from the available test result (TR) of the test (1) that comprises version 1 (V1) of the system under test (SUT), and the expected result of the test that comprises version 3 (V3) of the system under test (SUT) is calculated by means of a rule (5) from the expected test result (TR) of the test (1) that comprises version 2 (V2) of the system under test (SUT). In the second calculation, the probability of the expected test result (TR) derived from the previous calculation is taken into account. By way of example, if in the previous example for FIG. 4 the test result (TR) of the test (1) that comprises the system under test (SUT) in version 2 (V2) is not present, but instead is calculated in an analogous way, with a probability of 99%, from an existing test result (TR) of a test (1) comprising the system under test (SUT) in version 1 (V1). Calculating the test result (TR) for the test (1) comprising the system under test (SUT) in version 3 (V3) by means of the same rule (5) likewise results in the test result (TR) for the test (1) comprising the system under test (SUT) in version 3 (V3) being 99% equal to the test result (TR) for the test (1) comprising the system under test (SUT) in version 2 (V2). In this case, there results a total of 98.01% (=(99/100)*(99/100)*100) for the probability that the test result (TR) for the test (1) comprising the system under test (SUT) in version 3 (V3) is the same as the test result (TR) for the test (1) comprising the system under test (SUT) in version 1 (V1). By way of an alternative to the different versions (V1, V2, V3), other variations of test cases (TC), test environments (TE) or systems under test (SUT), for example variants or different elements of an interrelated group, are also possible.

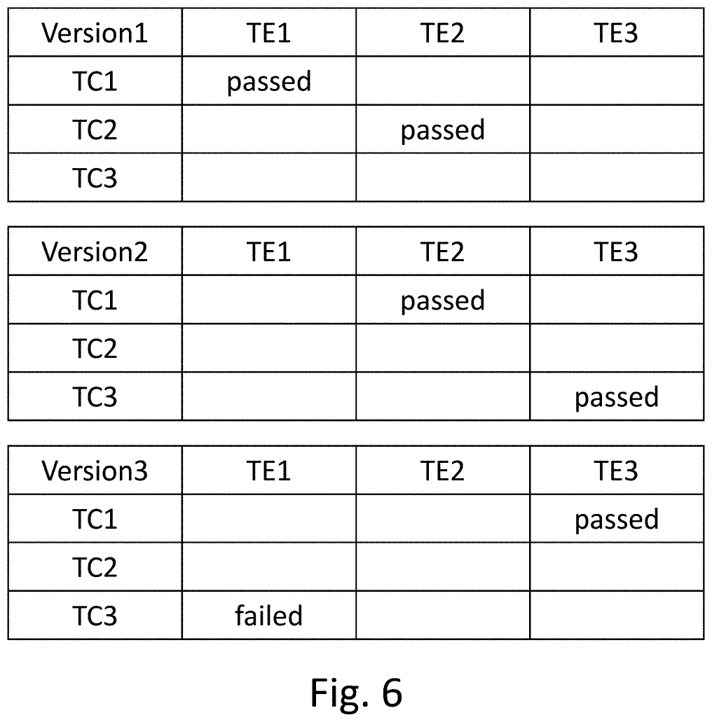

FIG. 6 illustrates the results (TR) of tests (1) in tabular form. Available options include different test environments (TE1, TE2, TE3), different test cases (TC1, TC2, TC3) and a system under test (SUT) in different, successive versions (Version1, Version2, Version3). The empty fields of the tables represent tests (1) for which there is no result (TR). By way of example, FIG. 5 shows one example of a database stored in a data repository (3).

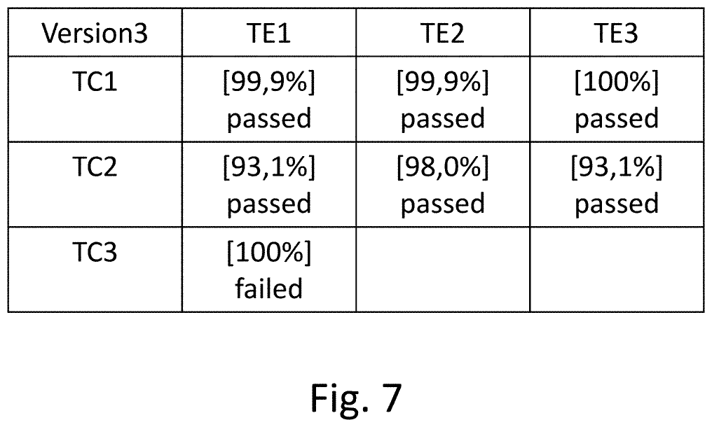

FIG. 7 illustrates how the product maturity of version 3 of the system under test (SUT) is presented in tabular form and analogously to the tables in FIG. 5. The individual fields of the table contain the expected results of the illustrated test (1), calculated by the method according to the invention, as well as the associated probabilities. It may easily be seen that the representation determined by the invention and shown in FIG. 7 gives an overview of the product maturity of the system under test (SUT) in Version 3 that is much better, because more complete, than the comparable representation in the lower third of FIG. 6. For further improved rapid readability, the fields of the table may also be displayed in color, in addition to or alternatively to the textual content. Typically in this case, green is used for tests (1) with the result “passed” and red is used for tests (1) with the result “failed”. To represent the probabilities, it is additionally possible to vary the hue or color intensity of the green and red fields.

Assuming that the system under test (SUT) is an ECU prototype of an automobile ECU responsible for controlling the function of the electric window regulator, the test environments (TE1, TE2, TE3) could be HIL simulators with different software configurations representing different vehicle types.

The test cases (TC1, TC2, TC3) could be, by way of example, the prevention of jamming when the window is closing (TC1), emergency opening of the window in case of an accident (TC2), and automatic closing of the window when the car is being shut down. The product maturity determined according to the invention, as shown in FIG. 7, may now be used to draw various conclusions depending on the evaluation criterion and development status. The lack of positive test results for test case TC3 may lead to it being executed again or for the first time, after a possible improvement of the corresponding functionality. It could also be decided that the current milestone in development (for example safety-relevant tests passed with over 90% probability) has been reached and that development will move on to the next step.

Additional information may likewise be obtained from the product maturity determined according to the invention, as shown in FIG. 7, or such information may be further condensed. For example, the conclusion may be drawn that fewer than four tests (1) have been evaluated as passed with a probability of over 90%.

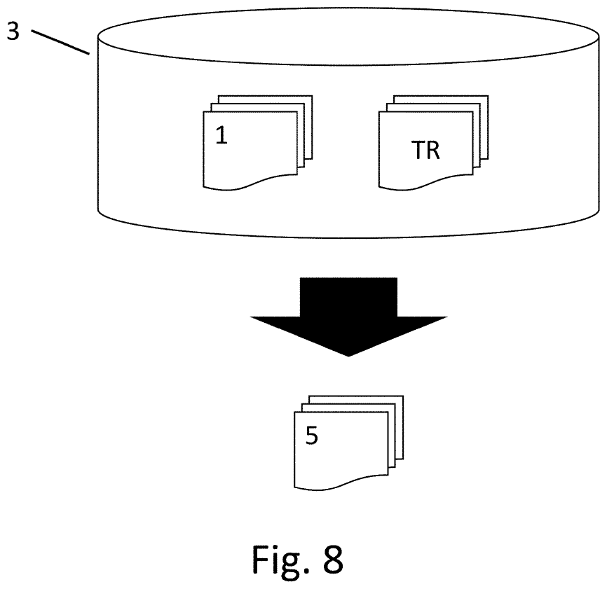

FIG. 8 schematically illustrates an automatic derivation of the rules (5), represented by the solid arrow, from a database stored in a data repository (3), comprising tests (1) and test results (TR). As shown in FIG. 2, the test results (TR) are assigned to tests (1). The automatic derivation may, for example, create one or more rules (5) from a frequently-occurring correlation. A possible example here is that a test (1), comprising a certain combination of a test case (TC) and a system under test (SUT), is associated with a result (TR) more frequently than a predetermined percentage threshold, and from this the rule (5) is derived that other tests (1), comprising the same combination of test case (TC) and system under test (SUT), will have the same result (TR) as the previously determined tests (1), with a probability corresponding to the threshold.

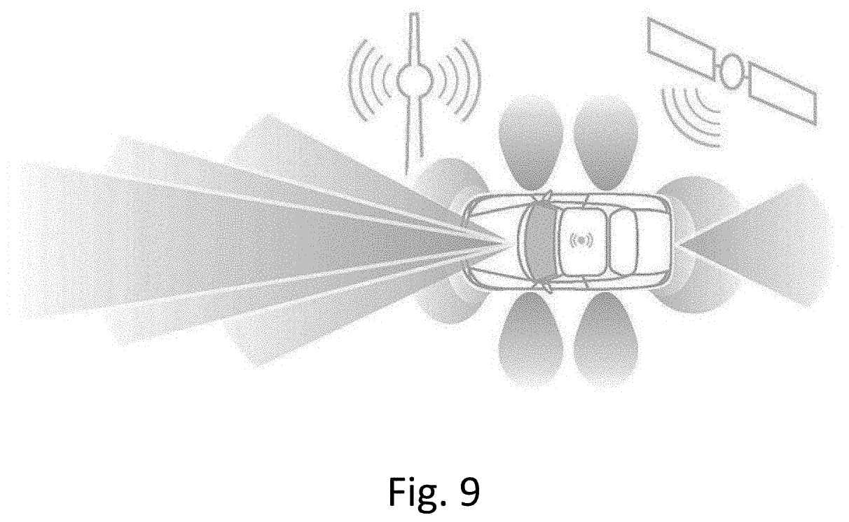

At least partially or even completely autonomously-driven vehicles have one or more sensors to collect data, in particular data about the environment of the vehicle. In addition, such vehicles typically have one or more interfaces for exchanging data with their environment. FIG. 9 illustrates this schematically. Typical such sensors are radar, lidar or optical camera sensors by means of which the environment is detected. Data exchange is usually accomplished via mobile radio standards (for example 4G or 5G). In addition, satellite-based systems (for example GPS) are often used for position determination.

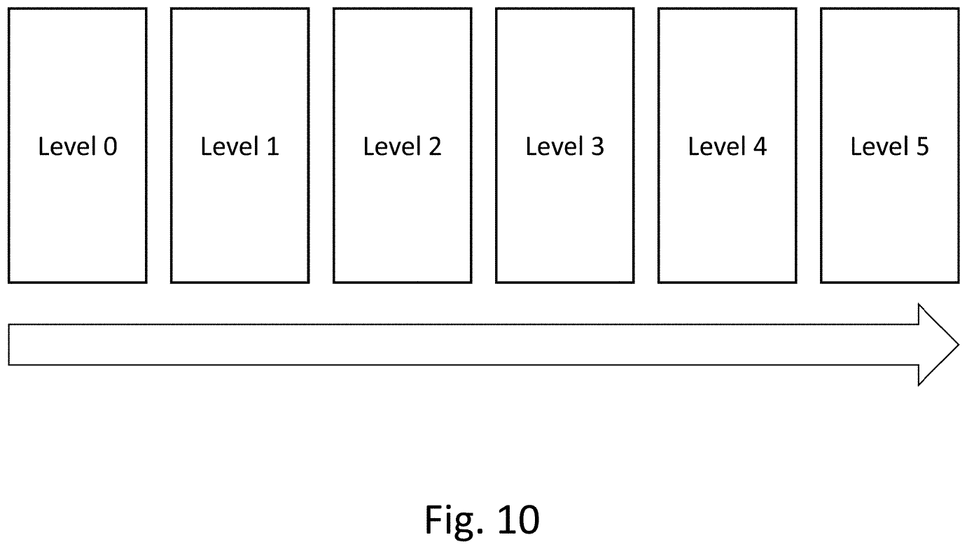

In the field of driver assistance systems, or the further development thereof into highly automated or even autonomous driving, different levels or degrees of automation are typically defined. These are illustrated in FIG. 10. Level 0 stands for a system without assistance systems, in which all driving maneuvers, in particular steering, acceleration and braking, are done by the driver alone. Level 1 is referred to as assisted driving, because either steering or acceleration and braking are temporarily automatic. Examples of known systems are systems for automatic cruise control or adaptive cruise control (ACC). At Level 2, the system temporarily takes over steering and also acceleration and braking. This degree of automation is referred to as semi-automated driving. In levels 1 and 2, the driver must be able to intervene at any time so as to be able to take back full control of the vehicle at any time. Although the system temporarily takes over parts of the driving tasks, the driver must be able to follow the traffic situation at all times and intervene within the driver's natural reaction time. Highly automated driving (HAD) is known as Level 3. At this level, the vehicle drives automatically and the driver merely provides a fallback position in case the system is unable to handle a traffic situation. In such cases, the system will ask the driver to intervene and execute a maneuver appropriate to the situation. For this purpose, the driver is given a finite time period that however exceeds the typical human reaction time. Accordingly, the driver's attention may temporarily turn away from the street traffic. In levels 4 and 5, the automated system takes full control and the driver no longer needs to intervene. In level 4 this may only apply in certain driving environments (for example expressway travel), while in level 5, the vehicle is able to handle any driving environment and thus may in practice operate without a driver.

These different levels of automation require different levels of safety when securing or testing the corresponding automated driving functions. Thus, depending on their risk, the product release or even only the next step in the development process may be executed with different levels of security with respect to product maturity. A level 3 system may only be required to have a 99% probability of having no errors, because the driver is available as a fallback position, while level 4 or 5 systems must have a 99.9% probability of not having any errors. By means of the method for determining product maturity according to the invention, it may be determined or evaluated whether these different threshold values have been reached.

Because product maturity is determined by the existing test results (TR), the distribution of the available test results (TR) governs the quality of the calculated product maturity. For example, if all available test results (TR) were generated using only one test environment (TE), the statements about test results (TR) on other test environments (TE) are probably not very meaningful in quality. In order to obtain as meaningful a product maturity as possible, it may therefore be advantageous to generate the available test results (TR) based on a predeterminable distribution of tests (1) that must be executed beforehand. This distribution may be a random distribution, for example. Knowledge about how the existing test results (TR) are distributed may then additionally be used to evaluate product maturity.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for determining a product maturity via at least one test, wherein a test comprises executing a test case by applying a test environment to a system under test, and wherein there is no available test result for at least one test, the method comprising:
predetermining rules for calculating a probability that a test with no available result will be successful or unsuccessful, wherein existing or expected test results are used as the input variables for the rules and probabilities are returned as output variables;
calculating, via at least part of the predetermined rules, the probability that a test with no available result will be successful or unsuccessful; and
presenting the product maturity as a function of the probabilities calculated.

2. A method for determining a product maturity via at least one test, wherein a test comprises executing a test case by applying a test environment to a system under test, and there is no available test result for at least one test, a system under test being an at least partially autonomously driven vehicle, a part of an at least partially autonomously driven vehicle or a functionality of an at least partially autonomously driven vehicle, a test case being a driving maneuver of the at least partially autonomously driven vehicle, a driving maneuver with the part of the at least partially autonomously driven vehicle or a driving maneuver in which the functionality of an at least partially autonomously driven vehicle is taken into account, a test environment being an environment or a virtual environment of the at least partially autonomously driven vehicle or of a vehicle comprising the part of the at least partially autonomously driven vehicle or the functionality of an at least partially autonomously driven vehicle, the method comprising:
predetermining rules for calculating a probability that a test with no available result will be successful or unsuccessful, wherein existing or expected test results are used as input variables for the rules and probabilities are returned as output variables;
calculating, via at least part of the predetermined rules, the probability that a test with no available result will be successful or unsuccessful; and
presenting the product maturity as a function of the probabilities calculated.

3. The method according to claim 1, wherein there is a first and a second version of a test case or a test environment or a system under test, and wherein the second version represents a development state of the test case or test environment or system under test that is later in time than the development state of the test case or test environment or system under test.

4. The method according to claim 3, wherein, either via the rules or provided in addition to the rules, a part of the present and expected results of the test is not taken into account when calculating the probability that a test will be successful or not successful, wherein the part of the results that is not taken into account depends on one or more versions of at least one test case, at least one test environment and/or at least one system under test, and wherein the test comprises the at least one test case, the at least one test environment and/or the at least one system under test.

5. The method according to claim 1, wherein the predetermined rules represent a technical or statistical relationship between at least a first test case, a first test environment or a first system under test in the first or second version and at least a second test case, a second test environment or a second system under test in the first or second version.

6. The method according to claim 1, wherein the result of a test take at least the values: “Test successful” or “Test failed”.

7. The method according to claim 1, wherein the predetermined rules are automatically created and/or verified by analysing a database of at least a part of the tests, comprising test cases, test environments, systems under test and/or results.

8. The method according to claim 7, wherein the analysis comprises a static evaluation of test interrelationships or interrelationships between tests with positive results.

9. The method according to claim 1, wherein before the step of calculating, a first group of tests is determined via a statistical distribution and results are available or generated for the first group of tests.

10. The method according to claim 9, wherein the determination of the tests of the first group of tests is based on one or more additional static distributions of test cases, test environments and/or systems under test.

11. The method according to claim 9, wherein the static distribution and/or one or more of the other static distributions are random distributions.

12. The method according to claim 9, wherein the calculation of the probability that a test with no available result will be successful or unsuccessful is a function of the static distribution of tests, test cases, test environments and/or systems under test.

13. The method according to claim 1, wherein the product maturity is presented in the form of a numerical test coverage, a percentage, in the form of a graphic, or a color-coded graphic.

14. The method according to claim 1, wherein one or more criteria are predetermined and a part of the test for which a probability that the test will be successful or unsuccessful has been calculated is executed or proposed, and wherein the executed or proposed tests meet at least one of the predetermined criteria.

15. The method according to claim 14, wherein at least one of the predetermined criteria is that a threshold value for the probability that the test will be successful or unsuccessful either is exceeded or is not reached.

16. The method according to claim 1, wherein a weighting is assigned to a test case, a test environment, a system under test or a combination of at least two elements selected from a test case, a test environment and/or a system under test, and wherein the weighting is applied when calculating the probability that a test with no available result will be successful or unsuccessful in the calculating step and/or presenting product maturity.

17. The method according to claim 1, wherein a product maturity threshold value is specified, and if the product maturity threshold value is exceeded, the system under test is released for a further development step.

18. The method according to claim 17, wherein the system under test is assigned to a class of systems under test via a level of automation, and wherein the product maturity threshold value is determined as a function of the assigned class.

19. A test system for testing a technical system, an electronic control unit, or part of an electronic control unit, wherein the test system implements the method according to claim 1.
